(19) United States
(12) Patent Application Publication
(10) Pub. No.: US 2009/0100931 A1
(43) Pub. Date: Apr. 23, 2009

(54) Physical quantity sensor

(75) Inventor: Hirofumi Higuchi, Okazaki-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/232,120

(22) Filed: Sep. 11, 2008

(30) Foreign Application Priority Data
Oct. 17, 2007 (JP) 2007-270245

(51) Int. Cl. G01P 15/125

(52) U.S. Cl. 73/514.32

(57) ABSTRACT

A physical quantity sensor has a weight mass movable in a detection direction. Auxiliary capacitors are formed at both side ends of the weight mass in a non-detection direction by auxiliary movable electrodes and auxiliary fixed electrodes, respectively. When capacitances of the auxiliary capacitors change due to movement of the weight mass in the non-detection direction, a limiter circuit feedback-controls voltages applied to the auxiliary fixed electrodes to maintain the position of the weight mass unchanged. Thus, the weight mass is limited from moving in the non-detection direction thereby to improve accuracy in detection of the movement in the detection direction.

### CROSS REFERENCE TO RELATED APPLICATION

This patent application is based on and incorporates herein by reference the contents of Japanese Patent Application No. 2007-270245 filed on Oct. 17, 2007.

### FIELD OF THE INVENTION

The present invention relates to a physical quantity sensor.

### BACKGROUND OF THE INVENTION

A physical quantity sensor of a micro-electromechanical system (MEMS) is disclosed in U.S. Pat. No. 6,267,008 (JP 3729191) for instance. This physical quantity sensor detects physical quantities such as acceleration or angular velocity based on changes in electrostatic capacitance of a capacitor. The changes in the electostatic capacitance are caused, when a weight mass of the physical quantity sensor is moved by inertia force due to acceleration or Coriolis force. A voltage difference is caused between a movable electrode and a fixed electrode of the weight mass facing each other to counter the movement of the weight mass. The voltage applied between the fixed electrode and the movable electrode to cause the voltage difference indicates the physical quantity applied to the weight mass, that is, the acceleration or the angular velocity.

In the physical quantity sensor, the weight mass is normally supported by beams at both side ends, which are in a direction of detection of movement. The weight mass is thus movable in the direction of detecting the physical quantity. The beams for supporting the weight mass varies from piece to piece in respect of operation characteristics due to manufacturing errors, etc. It is therefore likely that the weigh mass also moves in directions other than the detection direction. If the weight mass moves in the other directions than the detection direction, such a movement will also cause changes in the capacitance of the capacitor. This change will increase detection noise.

### SUMMARY OF THE INVENTION

It is therefore an object of the present invention to provide a physical quantity sensor, in which a weight mass is limited from moving in directions other than a detection direction.

According to one aspect of the present invention, a physical quantity sensor comprises a weight mass, main capacitors, a detector circuit, auxiliary capacitors and a limiter circuit. The weight mass is supported at both side ends in a detection direction in which a movement is to be detected. The main capacitors are provided at the side ends in the detection direction. Each main capacitor includes a main movable electrode and a main fixed electrode, which face each other in the detection direction to store electric charge therebetween. The detector circuit is connected to the main capacitors for detecting movement of the weight mass based on changes in the capacitances of the main capacitors. The auxiliary capacitors are provided at both side ends of the weight mass in a non-detection direction, which is generally perpendicular to the detection direction. Each auxiliary capacitor includes an auxiliary movable electrode and an auxiliary fixed electrode, which face each other in the non-detection direction to store electric charge therebetween. The limiter circuit is connected to the auxiliary capacitors and configured to limit movement of the weight mass in the non-detection direction by causing a voltage difference between the auxiliary movable electrode and the auxiliary fixed electrode.

According to another aspect of the present invention, a physical quantity sensor comprises a weight mass, a plurality of capacitors and a circuit. The weight mass is supported at both side ends in a detection direction in which a movement is to be detected. The capacitors are provided at each side end of the weight mass in the detection direction. Each capacitor includes a movable electrode and a fixed electrode, which face each other in the detection direction to store electric charge therebetween. The circuit is connected to the plurality of capacitors for detecting movement of the weight mass based on changes in the capacitances of the capacitors. The circuit is configured to limit rotation of the weight mass about a center of the weight mass by causing a voltage difference between the movable electrode and the fixed electrode.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic view of a physical quantity sensor according to a first embodiment of the present invention;

FIG. 2 is a sectional view of the physical quantity sensor taken along a line II-II in FIG. 1;

FIG. 3 is a schematic view of a physical quantity sensor according to a second embodiment of the present invention;

FIG. 4 is a sectional view of the physical quantity sensor taken along a line IV-IV in FIG. 3;

FIG. 5 is a schematic view of a physical quantity sensor according to a third embodiment of the present invention;

FIG. 6 is a schematic view of a physical quantity sensor according to a fourth embodiment of the present invention; and

FIG. 7 is a schematic view of a physical quantity sensor according to a fifth embodiment of the present invention.

### DETAILED DESCRIPTION OF THE PREFERRED EMBODIMENT

The present invention will be described in detail with reference to various embodiments shown in the accompanying drawings, in which the same reference numerals denote the same or similar parts throughout the embodiments.

### First Embodiment

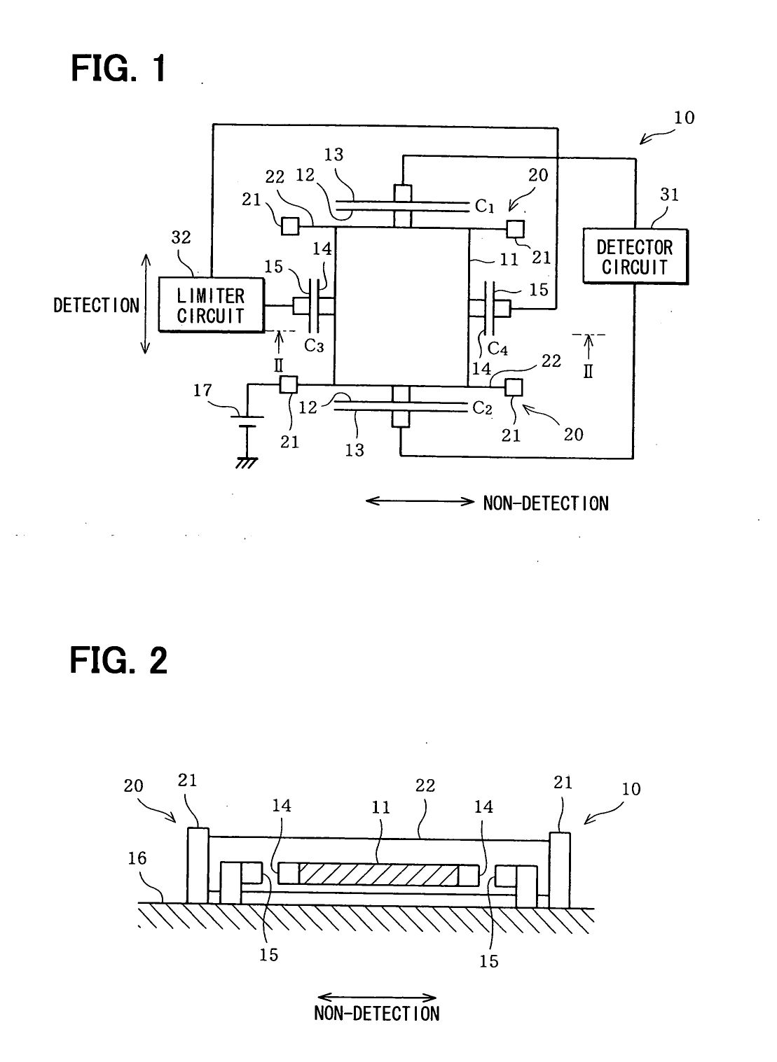

Referring first to FIGS. 1 and 2, a physical quantity sensor 10 is configured with a rectangle-shaped weight mass 11, supporting units 20, main movable electrodes 12, main fixed electrodes 13, auxiliary movable electrodes 14, auxiliary fixed electrodes 15, a detector circuit 31 and a limiter circuit 32. As shown in FIG. 2, the weight mass 11, the supporting units 20, the main movable electrodes 12, the main fixed electrodes 13, the auxiliary movable electrodes 14 and the auxiliary fixed electrodes 15 are formed on a substrate 16 made of a semiconductor in a single chip.

Each of the detector circuit 31 and the limiter circuit 32 is configured by a microcomputer including, for instance, a CPU, a ROM, a RAM and the like. The detector circuit 31 and the limiter circuit 32 may be formed on the same sensor chip of the physical quantity sensor or on a separate chip different from that of the physical quantity sensor 10.

The weight mass 11 is supported by supporting units 20 over the substrate 16 at two side ends. The weight mass 11 is spaced apart a predetermined distance from the substrate 16 by the supporting units 20. Each supporting unit 20 includes a pair of posts 21 and a beam 22. The post 21 is raised generally perpendicularly from the substrate 16. The beam 22 is coupled to the posts 21 at its ends. The weight mass 11 is supported by the beams 22 at its side ends, which are in the direction of detection (up-down direction in FIG. 1). That is, the weight mass 11 is coupled to the beams 22 at its side ends facing each other in the detection direction. Thus, the weight mass 11 is supported movably in the detection direction.

The movable electrodes 12 are formed integrally with the weight mass 11 together with the beams 22. The movable electrodes 12 are provided on the beams 22 at the side ends of the weight mass 11, respectively. The movable electrodes 12 are thus movable in the detection direction integrally with the weight mass 11 and the beams 22. The fixed electrodes 13 are fixedly provided to face the movable electrodes 12, respectively. Thus, the movable electrode 12 and the fixed electrode 13 are provided in pair at each of the side ends of the weight mass 11, that is, at an upside end and a downside end of the weight mass 11 in FIG. 1. The movable electrode 12 and the fixed electrode 13 are spaced apart from each other in the detection direction. The movable electrodes 12 and the fixed electrodes 13 thus form main capacitors C1 and C2 at both side ends of the weight mass 11. The fixed electrodes 13 are electrically connected to the detector circuit 31, which detects physical quantity applied to the weight mass 11.

The movable electrodes 14 are formed on the other side ends of the weight mass 11, which face each other in a non-detection direction (left-right direction in FIG. 1). This non-detection direction is perpendicular to the detection direction. The movable electrodes 14 are formed integrally with the side ends of the weight mass 11. The fixed electrodes 15 are formed to face the movable electrodes 14, respectively. Thus, the movable electrode 14 and the fixed electrode 15 are provided in pair at each of the side ends of the weight mass 11, that is, at a left side end and a right side end of the weight mass 11 in FIG. 1. The movable electrode 14 and the fixed electrode are spaced apart form each other in the non-detection direction. The movable electrodes 14 and the fixed electrodes 15 thus form auxiliary capacitors C3 and C4 at both side ends of the weight mass 11. The fixed electrodes are electrically connected to the limiter circuit 32, which limits the movement of the weight mass 11 in the direction other than the detection direction.

The weight mass 11 is connected to an electric power source 17 through the posts 21 and beams 22, so that a potential difference may be produced between a movable side (weight mass 11 and movable electrodes 12, 14) and a fixed side (fixed electrodes 13, 15). As a result, electric charges are stored in the capacitors C1, C2 formed by the movable electrodes 12 and the fixed electrodes 13 and also in the capacitors C3, C4 formed by the movable electrodes 14 and the fixed electrodes 15. The capacitors C1 and C2 vary respective capacitances when the distances between the movable electrodes 12 and the fixed electrodes 13 facing each other are varied, respectively. Similarly, the capacitors C3 and C4 vary respective capacitances when the distances between the movable electrodes 14 and the fixed electrodes 15 facing each other are varied, respectively.

Spaces between the movable electrodes 12 and the fixed electrodes 13 forming the capacitors C1, C2 and between the movable electrodes 14 and the fixed electrodes 15 forming the capacitors C3, C4 may be filled with air or other gas, liquid or solid dielectric material.

The detector circuit 31 may be constructed as a servo circuit to control the movement of the weight mass 11 in the detection direction. The detector circuit 31 is configured to generate voltage differences between the movable electrodes 12 and the fixed electrodes 13 to counter changes in the capacitances of the capacitors C1 and C2 formed between the movable electrodes 12 and the fixed electrodes 13. In practice, the average voltages (direct current voltage components) of the respective electrodes are controlled to differ from each other thereby to exert electrostatic force.

More specifically, when acceleration or Coriolis force is applied to the physical quantity sensor 10, the weight mass 11 tends to move by inertia force. The detector circuit 31 is configured to detect the movement (displacement) of the weight mass 11 based on the changes in the capacitances of the capacitors C1 and C2. The detector circuit 31 feedback-controls the direct current voltage components of the voltages of the fixed electrodes 13 based on the detected movement of the weight mass 11 to counter the movement of the weight mass 11. Thus, the weight mass 11 is controlled to stay at the predetermined position even when acceleration or Coriollis force is applied.

The direct current voltages applied to the fixed electrodes 13 are proportional to the force applied to the weight mass 11. The detector circuit 31 thus detects the force (acceleration or Coriollis force) applied to the weight mass 11 based on the direct current voltages applied to the fixed electrodes 13.

The limiter circuit 32 may be constructed as a servo circuit in a similar manner as the detector circuit 31 to control the movement of the weight mass 11 by limiting the same in the non-detection direction perpendicular to the detection direction. The limiter circuit 32 is configured to generate voltage differences between the movable electrodes 14 and the fixed electrodes 15 to counter changes in the capacitances of the capacitors C3 and C4 formed between the movable electrodes 14 and the fixed electrodes 15. The physical quantity sensor 10 has variations different from sensor to sensor in respect of shapes or positions of the posts 21 or the beams 22. These variations in shapes or positions of the posts 21 or the beams 22 will cause movement of the weight mass in the non-detection direction, which is different from the detection direction and not intended to move in design.

If the weight mass 11 is moved in the non-detection direction, the capacitances of the capacitors C1 and C2 will change in response to this movement. The changes of the capacitances of the capacitors C1 and C2 caused by the movement of the weight mass 11 in the non-detection direction will result in noise. This noise will lower the accuracy in detection of the inertia force in the detection direction, which the physical quantity sensor 10 is required to detect.

The limiter circuit 32 is configured to detect the movement of the weight mass 11 in the non-detection direction based on the changes in the capacitances of the capacitors C3 and C4 formed between the movable electrodes 14 and the fixed electrodes 15. The limiter circuit 32 feedback-controls the direct current voltage components of the fixed electrodes 15 based on the detected movement of weight mass 11 in the non-detection direction to counter the movement of the weight mass 11 in the non-detection direction. The limiter circuit 32 thus limits the movement of the weight mass 11 in the non-detection direction.

The weight mass 11 in the first embodiment has the movable electrodes 14, which form the capacitors C3 and C4 together with the fixed electrodes 15. The limiter circuit 32 feedback-controls the direct current voltage applied to the fixed electrodes 15, when the capacitances of the capacitors C3 and C4 change in response to the movement of the weight mass 11 in the non-detection direction. With this feedback control, the weight mass 11 is limited by the limiter circuit 32 from moving in the non-detection direction. As a result, even if the posts 21 and the beams 22 differ from piece to piece, the movement of the weight mass 11 in the detection other than the detection direction is minimized. The accuracy in detection of the movement of the weight mass 11 in the detection direction is improved.

In the first embodiment, the limiter circuit 32 maintains the weight mass 11 at the predetermined position by feedback-controlling the direct current voltages applied to the fixed electrodes 15. Further, the limiter circuit 32 only controls the weight mass 11 to maintain its position, and does not detect the voltages applied to the fixed electrodes 15. It is however possible to configure the limiter circuit 32 to detect the voltages applied to the fixed electrodes 15.

The weight mass 11 is supported by supporting units 20 at both side ends, which are opposite in the detection direction. If the voltages applied to the fixed electrodes 15 become excessive, it is likely that the weight mass 11 or the supporting units 20 has abnormality or failure. It is therefore possible to configure the detector circuit 31 to stop its physical quantity detection operation, when the voltages applied to the fixed electrodes 15 exceed a predetermined threshold level. Thus, any adversary influence of an abnormal detection signal on the other systems can be prevented from arising by stopping the detection operation.

### Second Embodiment

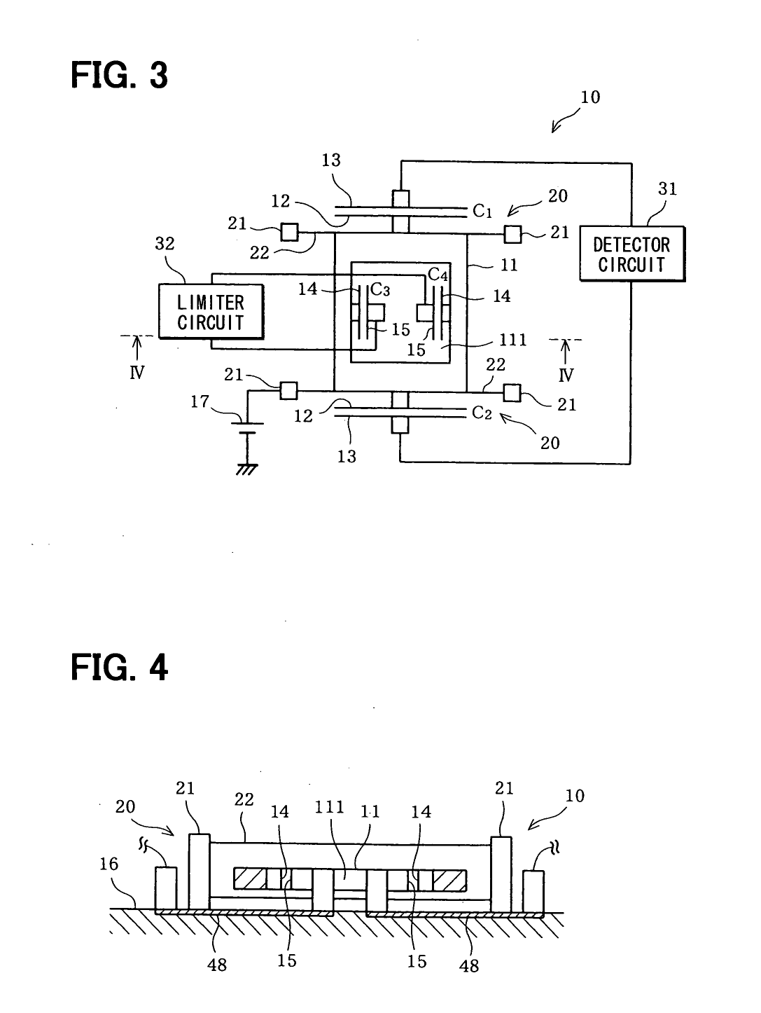

In a second embodiment, as shown in FIG. 3, the weight mass 11 of the physical quantity sensor 10 is shaped in a ring form, which has a central opening 111 in its central part. The opening 111 may be in a square shape. The auxiliary movable electrodes 14 are provided radially inside the weight mass 11 in such a manner that they protrude into the opening 111 from the inner side ends. The auxiliary fixed electrodes 15 are provided to face the movable electrodes 14 in the opening 111. The fixed electrodes 15 are electrically connected to the limiter circuit 32, through a conductive film layers 48 as shown in FIG. 4.

Since the movable electrodes 14 and the fixed electrodes 15 are provided inside the opening 111, the outer peripheral area occupied by the weight mass 11 and the movable electrodes 14 are reduced in size in comparison with that in the first embodiment. As a result, the size of the moving part of the physical quantity sensor 10 can be reduced.

### Third Embodiment

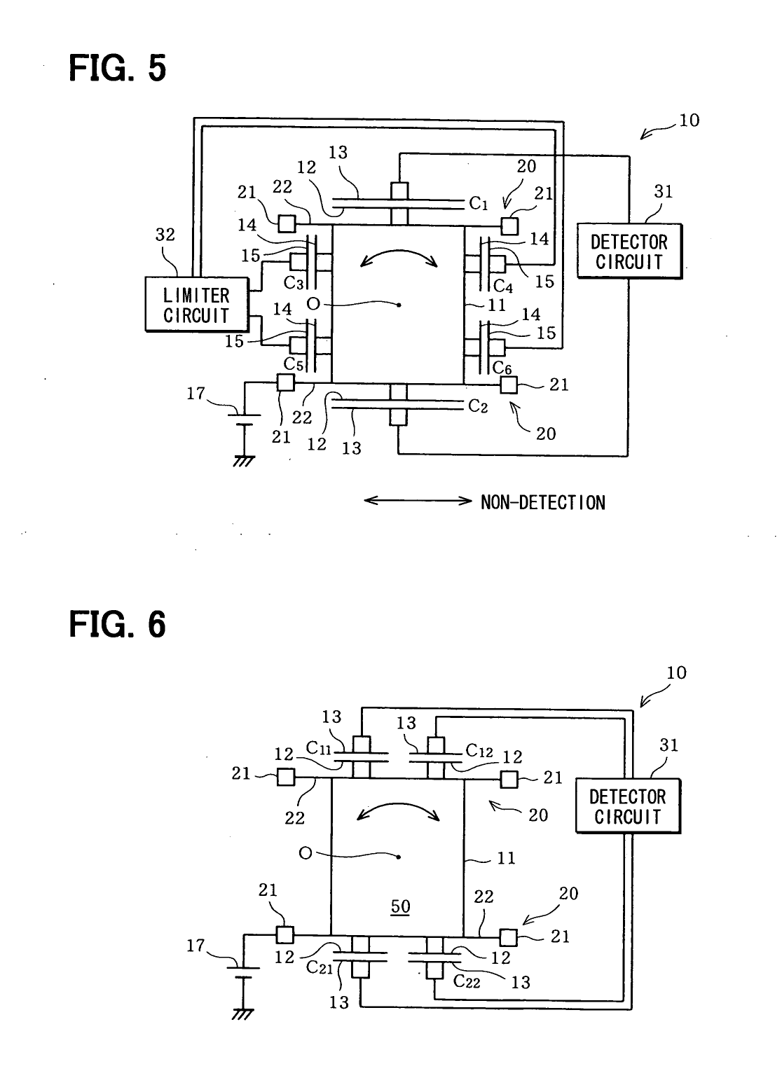

In a third embodiment, as shown in FIG. 5, the physical quantity sensor 10 has two auxiliary movable electrodes 14 on each side end of the weight mass 11. Two auxiliary fixed electrodes 15 are provided to face the movable electrodes 14, respectively, on each side end of the weight mass 11. Thus, four auxiliary capacitors C3 to C6, two for each side end in the non-detection direction, are formed in such a manner that each auxiliary capacitor is formed in correspondence to each corner of the weight mass 11.

The fixed electrodes 15 are electrically connected to the limiter circuit 32 so that the direct current voltages applied to the fixed electrodes 15 are varied to cause voltage differences in the capacitors C3 to C6.

The weight mass 11 will not only move in the non-detection direction (left-right direction in FIG. 5) but also rotate about a center C of the weight mass 11, if the positions and the shapes of the posts 21 and the beams 22 are not manufactured as designed, that is, if they are not balanced well. Specifically, the weight mass 11 will rotate in the clockwise or counter-clockwise direction about the center O in FIG. 5. When the weight mass 11 rotates about the center O, the capacitances are caused to change between the capacitors C3 and C6 provided diagonally and between the capacitors C4 and C5 provided diagonally depending on the direction of rotation.

The limiter circuit 32 changes the voltages of the fixed electrodes 15 of the capacitors C3 to C6, which caused capacitance changes therein, to cause voltage differences relative to the movable electrodes 14 and therby counter the capacitance changes.

Specifically, the limiter circuit 32 detects rotation of the weight mass 11 based on changes in the capacitances of the capacitors C3 to C6, and feedback-controls the direct current voltages applied to the fixed electrodes 15 to counter the rotation of the weight mass 11 based on the detected rotation. Thus, the limiter circuit 32 limits the rotation of the weight mass 11.

According to the third embodiment, the auxiliary capacitors C3 to C6 are formed near the four corners of the weight mass 11 and the capacitances of the capacitors C3 to C6 are controlled by the limiter circuit 32. Therefore, the weight mass 11 is limited from not only moving in the non-detection direction but also rotating about the center O.

As a result, even if the posts 21 and beams 22 have manufacturing errors, the movement in the non-detection direction and the rotation about the center O can be minimized. The accuracy in detecting the displacement of the weight mass 11 in the detection direction can be enhanced.

### Fourth Embodiment

In a fourth embodiment, as shown in FIG. 6, the physical quantity sensor 10 has two movable electrodes 12 at each side end of the weight mass 11 in the detection direction (up-down direction in FIG. 6). Two fixed electrodes 13 are provided to face the two movable electrodes 12 in the detection direction, respectively. Thus, four capacitors C11, C12, C21 and C22 are formed near four corners of the weight mass 11, respectively. The fixed electrodes 13 are electrically connected to the detector circuit 31, which controls the direct current voltage applied to the fixed electrodes 13.

The weight mass 11 will rotate in the clockwise or counter-clockwise direction about the center O as described with reference to the third embodiment. In the fourth embodiment, the capacitances will change between the capacitors C11 and C22 provided diagonally to each other and between the capacitors C12 and C21 provided diagonally to each other when the weight mass 11 rotates about the center C. This capacitance change depends on the direction of rotation.

The detector circuit 31 varies the voltages applied to the fixed electrodes 53 of the capacitors C11, C12, C21 and C22, which caused capacitance changes, in such a manner that voltage differences are produced between the movable electrodes 12 and the fixed electrodes 13 to counter the capacitance changes. Specifically, the detector circuit 31 detects the rotation of the weight mass 11 based on the capacitance changes in the capacitors C11, C12, C21 and C22, and feedback-controls the direct current voltages applied to the fixed electrodes 13 to thereby counter the rotation of the weight mass 11 based on the detected rotation of the weight mass 11.

According to the fourth embodiment, four capacitors C11, C12, C21, C22, two for each side end in the detection direction, are formed, and the respective capacitances are controlled to a predetermined capacitance value thereby to limit the weight mass 11 from rotating about the center O. Although the weight mass 11 is not limited form moving in the non-detection direction as opposed to the first to the third embodiments, it is restricted from rotating. As a result, even if the posts 21 and the beams 22 have manufacturing errors, the rotation of the weight mass 11 is minimized and the accuracy in detecting the displacement of the weight mass 11 in the detection direction is enhanced.

### Fifth Embodiment

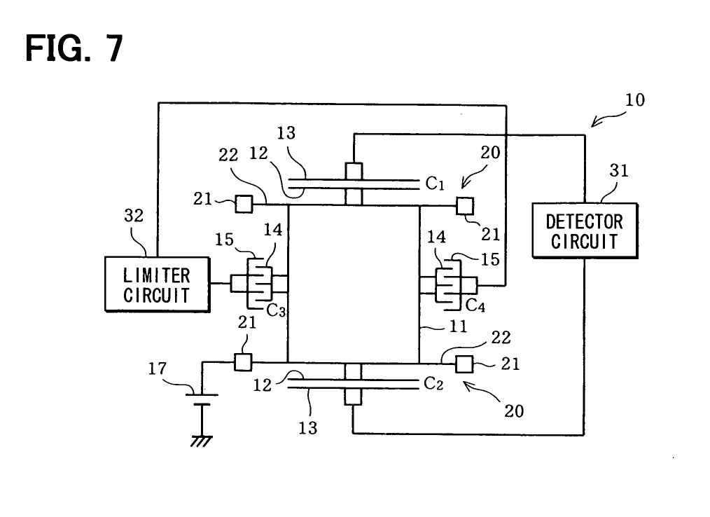

In a fifth embodiment, as shown in FIG. 7, the movable electrodes 14 and the fixed electrodes 15 of the auxiliary capacitors C3 and C4 are formed in a comb shape in place of a plate shape so that teeth of the movable electrodes 14 and the fixed electrodes 15 are interleaved with spaces therebetween. This comb shape electrode arrangement is advantageous in that a larger movement can be controlled than in the plate electrode arrangement and the movement control can be easily performed because the electrostatic force changes linearly relative to the displacement. The movable electrodes 12 and the fixed electrodes 13 of the main capacitors C1 and C2 may also be formed in the comb shape.

The above embodiments are only exemplary and may be modified in many other ways.

What is claimed is:

1. A physical quantity sensor comprising:
a weight mass supported at both side ends in a detection direction in which a movement is to be detected;
main capacitors provided at the side ends in the detection direction, each main capacitor including a main movable electrode and a main fixed electrode, which face each other in the detection direction to store electric charge therebetween;
a detector means connected to the main capacitors for detecting movement of the weight mass based on changes in the capacitances of the main capacitors;
auxiliary capacitors provided at both side ends of the weight mass in a non-detection direction, which is generally perpendicular to the detection direction, each auxiliary capacitor including an auxiliary movable electrode and an auxiliary fixed electrode, which face each other in the non-detection direction to store electric charge therebetween; and
a limiter means connected to the auxiliary capacitors and configured to limit movement of the weight mass in the non-detection direction by causing a voltage difference between the auxiliary movable electrode and the auxiliary fixed electrode.

2. The physical quantity sensor according to claim 1, wherein:
the auxiliary movable electrode of each auxiliary capacitor protrudes outside from the side end of the weight mass in the non-detection direction.

3. The physical quantity sensor according to claim 1, wherein:
the weight mass is shaped in a ring form, which has an opening radially inside thereof; and
the auxiliary movable electrode of each auxiliary capacitor protrudes inside from an inner side end of the weight mass in the non-detection direction.

4. The physical quantity sensor according to claim 1, wherein:
the auxiliary capacitor is provided at a plurality of locations at each side end of the weight mass in the non-detection direction; and
the limiter means is configured to limit the movement of the weight mass in the non-detection direction and a rotation of the weight mass about a center of the weight mass.

5. The physical quantity sensor according to claim 1, wherein:
the auxiliary movable electrode and the auxiliary fixed electrode are formed in a comb shape to have respective teeth, which are interleaved with each other.

6. A physical quantity sensor comprising:
a weight mass supported at both side ends in a detection direction in which a movement is to be detected;
a plurality of capacitors provided at each side end of the weight mass in the detection direction, each capacitor including a movable electrode and a fixed electrode, which face each other in the detection direction to store electric charge therebetween; and
a circuit connected to the plurality of capacitors for detecting movement of the weight mass based on changes in the capacitances of the capacitors,
wherein the circuit is configured to limit rotation of the weight mass about a center of the weight mass by causing a voltage difference between the movable electrode and the fixed electrode.
